(19) United States
(12) Patent Application Publication
(10) Pub. No.: US 2010/0178630 A1
(43) Pub. Date: Jul. 15, 2010

(54) Dental Tray

(76) Inventors: Jonathan Erik Novak, Green Bay, WI (US); Thomas Edwin Novak, Green Bay, WI (US); Keith Adam Novak, Holmen, WI (US)

Correspondence Address: BOYLE FREDRICKSON S.C., 840 North Plankinton Avenue, MILWAUKEE, WI, 53203, US

(21) Appl. No.: 12/687,589

(22) Filed: Jan. 14, 2010

Related U.S. Application Data
(60) Provisional application No. 61/144,573, filed on Jan. 14, 2009.

(51) Int. Cl. A61C 17/00; A61C 9/00

(52) U.S. Cl. 433/37; 433/216

(57) ABSTRACT

The present invention is dental tray for applying treatment gels to a person's teeth. The dental tray is sized and shaped to accommodate the dental arch of a person's oral cavity and is constructed from a temperature-dependent material such that the dental arch forms to the shape of the person's teeth profile at temperatures at or above that of the person's oral cavity. Once the dental tray is fitted to the person's specific teeth profile, a treatment gel is applied to the dental tray, the dental tray reinserted and the treatment gel applied to the person's teeth by contact therewith. In one embodiment of the present invention, the treatment gel is applied to the unformed dental tray such that the dental tray is fitted to the person's teeth profile simultaneous with the treatment thereof.

### CROSS-REFERENCE TO RELATED APPLICATION

This application claims priority to U.S. Provisional Application Ser. No. 61/144,573, filed Jan. 14, 2009, which is incorporated by reference herein.

### FIELD OF THE INVENTION

The present invention relates to a system for delivery of a tooth treatment gel to a person's teeth, and more particularly to fitted dental trays adapted for delivering tooth treatment gels to a patient's teeth.

### BACKGROUND

Dental trays are commonly used to hold various gels to the surface of a person's teeth. Popular applications include teeth bleaching, teeth mineralization, and teeth desensitization. In many applications, the treatment gels are recently catalyzed gels that are mixed at the time of use and require a tray-based delivery system. The tray is used to hold the treatment gel to the surface of the patient's teeth and to protect the gels from being diluted by the oral fluids present within the patient's mouth. However, historical custom tray applications required multiple visits to the dentist to form a custom tray or the use of a thermoformed tray that required the heating of the tray material, often ethylene vinyl acetate, to temperatures near 160° F. with the attendant difficulties caused thereby.

It has also been known to use strips for applying such gels to a person's teeth. Such strips are typically constructed from a plastic or polysaccharide and require the use of an applicator to bend the strip over the person's teeth. One such example is disclosed in U.S. Pat. No. 5,989,569 to Dirksing et al., which is hereby incorporated by reference. One known disadvantage of such applications is that the strips are only capable of covering a limited number of teeth at one time. That is, the strips provide limited coverage of the teeth such that multiple strips and/or applications of strips are necessary in order to fully apply the gel to the person's teeth thereby resulting in a relatively time intensive procedure. In addition, an adhesive is required to hold the strips in place. Another known method of applying such gels has been through the use of flat wax strips like those disclosed in U.S. Pat. No. 6,896,518 to Jacobs et al., which is hereby incorporated by reference thereto. Again, this method of applying treatment gels suffers from a number of disadvantages. For instance, this system of application requires the user to fold and manipulate the flat wax strip with a number of cutouts to facilitate bending of the wax strip to cover the teeth to thereby form a bend that is then filled with the gel. This process is relatively time consuming and the required folding and bending of the wax strips is relatively difficult to perform with any precision thereby resulting in a poor fit over the person's teeth. As such, a user may have to use a number of wax strips to obtain full coverage of the person's teeth, which can result in multiple treatment sessions which are relatively time consuming and cost-prohibitive.

A number of alternatives to the foregoing methods have been attempted; however, these alternatives still suffer from a number of disadvantages. For instance, foam trays, which are used extensively in dental offices to apply fluoride treatments, have been employed for applying bleaching gels and the like. However, these trays cannot be fitted and cannot be worn while the user is talking and carrying on normal everyday functions, but rather the user is required to sit with their teeth clenched to hold the application gels in place, making such treatment an uncomfortable experience.

Thus, it is desired to provide a device and method for applying treatment gels to a person's teeth that overcomes the foregoing disadvantages, holding such treatment gels by the surface of a person's teeth. Further, it is desirable to protect the gels from dilution by oral fluids. In addition, it is desirable to provide a device and method that allows a user to carry on day-to-day functions while allowing the application of the gels to the person's teeth for an extended period of time. Finally, it is desirable to provide a low cost system of applying treatment gels that is also relatively easy to use.

### SUMMARY OF INVENTION

The present invention is a device and method for applying treatment gels to a person's teeth that overcomes the disadvantages of the prior art. The device comprises a dental tray constructed from wax. The dental tray is shaped and sized for insertion into a person's oral cavity. The dental tray is configured to immediately conform to the shape of the person's oral cavity upon insertion therein. In a preferred embodiment, the dental tray conforms to the person's teeth in less than 10 seconds. In a more preferred embodiment, the dental tray conforms to a person's teeth within 3 and 10 seconds. The dental tray is configured for holding various treatment gels of the kind generally known in the art. For instance, the dental tray may hold bleaching and other viscous gels. In particular, the dental tray of the present invention is configured to conform to the person's oral cavity while holding the treatment gels therein such that the gels are held snugly against the person's teeth for application of the gels thereto.

In one embodiment of the present invention, the dental tray may include a surface sized and shaped to hold gels. Alternatively, the dental tray may be substantially smooth.

The dental trays are preferably constructed from a material, such as wax, capable of reuse and sufficiently inexpensive to fabricate such that the dental trays may be disposable. Various other features, advantages and objects of the present invention will be made apparent from the following detailed description and the drawings.

### DESCRIPTION OF THE DRAWINGS

Preferred exemplary embodiments of the invention are illustrated in the accompanying drawings in which like reference numerals represent like parts throughout and in which:

FIG. 1 is an isometric view of a dental tray according to the present invention prior to fitting a user's teeth profile;

FIG. 2 is an isometric view of a bottom of the dental tray of FIG. 1;

FIG. 3 is a top plan view of the dental tray of FIG. 1 showing an applied treatment gel in phantom;

FIG. 4 is a front elevation view of the dental tray of FIG. 1;

FIG. 5 is a side elevation view of the dental tray of FIG. 1;

FIG. 6 is a bottom plan view of the dental tray of FIG. 1;

FIG. 7 is an isometric view of the dental tray according the present invention after being fitted to a particular user's teeth profile and showing the application of a treatment gel to a trough of the dental tray; and

FIG. 8 is an isometric view of the dental tray of FIG. 7 showing an alternative application of treatment gel.

### DETAILED DESCRIPTION

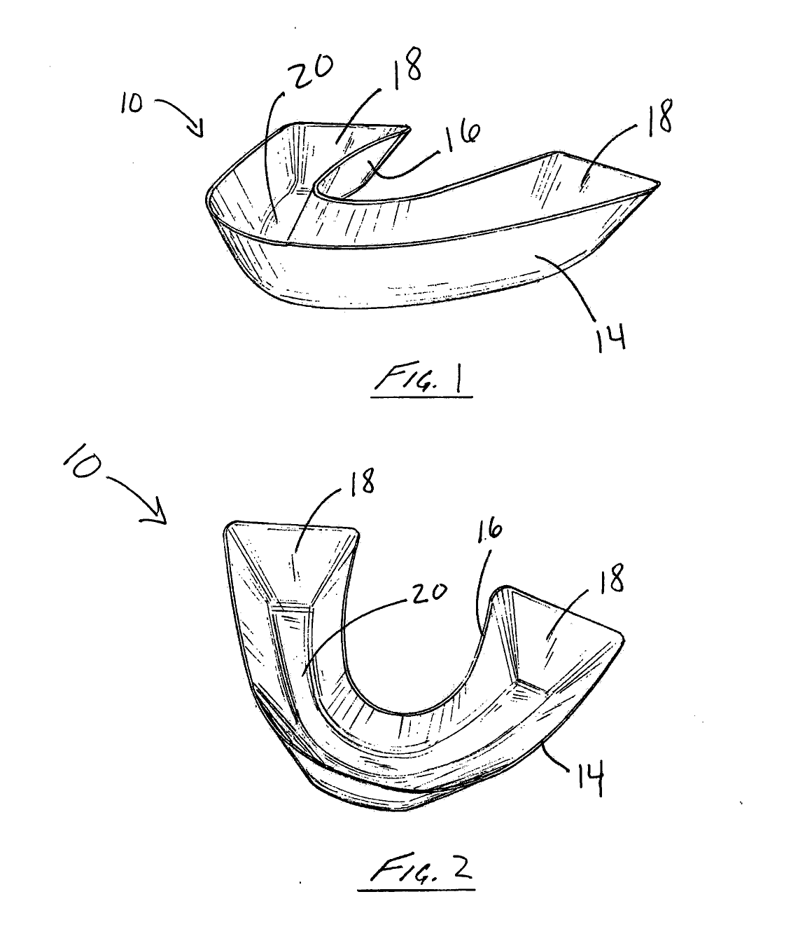

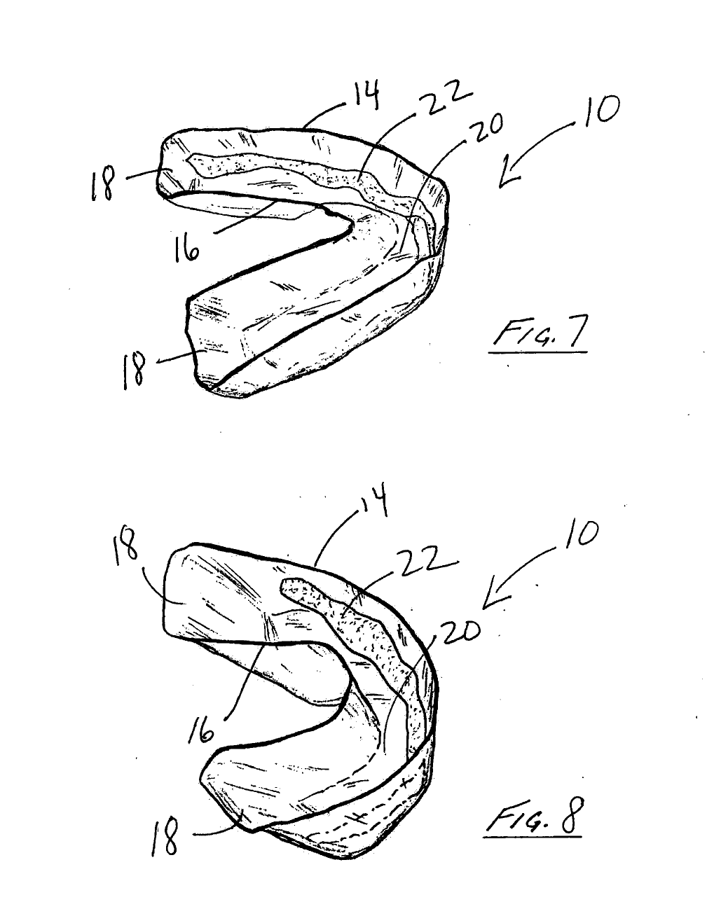

Referring now to the drawings, and initially to FIGS. 1-6, a dental tray 10 according to the present invention is illustrated. The dental tray 10 of the present invention is constructed from a relatively pliable material such as, for example, wax, though other materials having similar such characteristics may be utilized in practicing the present invention. Preferably the dental tray 10 is constructed of a material that is capable of being fitted without memory at temperatures at and above the temperatures of the oral cavity, yet the material allows the dental tray 10 to retain its substantial form while it is present within the oral cavity. That is, while the material is relatively pliable at temperatures at or above the temperatures of the oral cavity such that the dental tray 10 may be molded to the person's teeth profile, the material is sturdy enough such that it remains tight against the person's teeth during application of treatment gels. Further, the material allows near-instant fitting to a person's teeth profile without the use of an external heat source and without the time and expense of a dentist visit. Further, the temperature-dependent softness further allows the dental tray 10 to relax at points of irritation along the person's teeth profile and within the oral cavity thereby making the dental tray 10 more comfortable to wear. In a preferred embodiment, the dental tray 10 is constructed from a food grade wax such that the dental tray 10 may be fitted in situ. In another preferred embodiment, the dental tray 10 is constructed from a combination of at least 50% wax and known polymeric compounds that are compatible with the objectives of the present invention.

The dental tray 10 as shown in FIGS. 1-3 is universally shaped so as to accommodate the oral cavity of practically any person. As is generally understood, the dental tray 10 of the present invention may comprise a plurality of different sizes so as to accommodate persons of differing oral cavity sizes such as, for example, children. The dental tray 10 is preformed and contoured so as to accommodate a person's oral cavity. Further, as will be explained in detail herein, the dental tray 10 is configured to be instantly fitted to a particular person's oral cavity. That is, the dental tray 10 is capable of being fitted upon insertion into a person's oral cavity in less than 10 seconds to that particular person's unique oral cavity size and shape. More preferably, the dental tray 10 is capable of conforming to or otherwise being fitted to the person's unique oral cavity within between approximately 3 and 10 seconds. Further, the dental tray 10 of the present invention is adapted and configured to be selectively disposable. Alternatively, if desired, the dental tray 10 can be configured for reuse by the same person after cleaning thereof. The dental tray 10 according to the present invention may be made by any number of known processes, including, but not limited to injection molding, dip molding, and form molding.

Dental tray 10 comprises a generally semi-circular shape. Dental tray 10 includes a bottom wall 12, which cooperates with a pair of opposing sidewalls, i.e., a labial sidewall 14 and a lingual sidewall 16 extending upwardly from bottom wall 12, and a pair of spans 18. Spans 18 serve to form an end wall and interconnect the labial and lingual sidewalls 14 and 16, respectively. In particular, spans 18 are configured to interconnect the outer labial wall and the inner inguinal walls of the dental tray 10. In this manner, the spans 18 render manufacture of dental trays 10 relatively simple as compared to traditional dental trays, thereby resulting in a low-cost dental tray that may be disposable as desired. Spans 18 are configured for covering the person's molars and in particular, are configured to accommodate the expansion about the molars and surfaces thereof that is typically present within a person. Specifically, the spans 18 generally extend upwardly from the bottom wall 12 and rearwardly with respect to a point of maximum curvature of the dental tray 10. Accordingly, the spans 18 are positioned so as to circle or otherwise surround a person's molars such that when the dental tray 10 is inserted into a person's oral cavity, the spans 18 are allowed to mold or conform around the person's molars for a snug fit therearound. In this way, the spans 18 form a seal around the molars and thereby protect the treatment gels used in combination with dental tray 10 from dilution with the person's saliva. Further, the spans 18 serve to assist in holding the dental tray snug against the person's teeth such that the treatment gels are held directly to the surfaces thereof for improved efficacy of the various dental treatments employed with the dental tray 10.

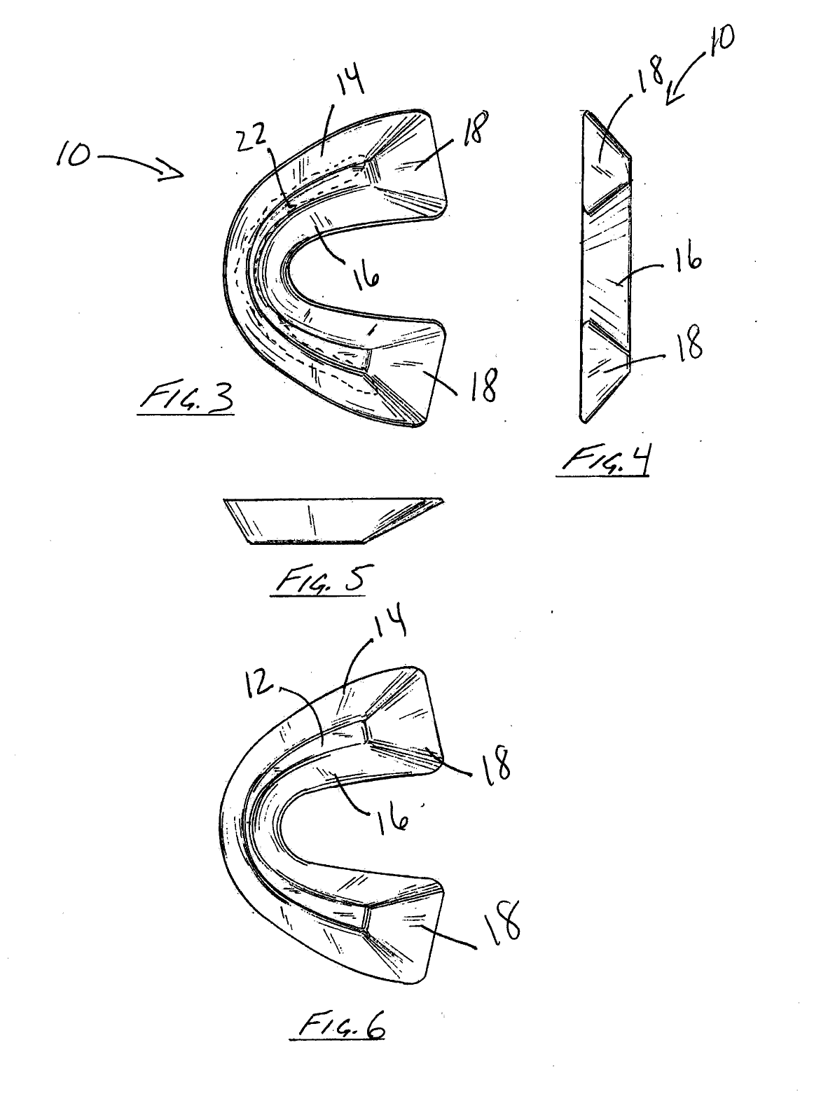

The sidewalls 14 and 16 and spans 18 cooperate to define a recessed portion therebetween in the form of trough 20. Trough 20 is configured for receiving the person's teeth therein, and the sidewalls 14 and 16 and spans 18 cooperate to securely retain the person's teeth therein. Referring momentarily to FIG. 3, trough 20 is shown with a treatment gel 22 being shown in phantom. As will be explained in detail herein, treatment gel 22 may be applied to the trough 20 either before or after the dental tray 10 is fitted to a person's teeth profile. In the former case, the fitting of the tray occurs simultaneously with the application of the treatment gel 22 to the person's teeth.

In operation, the dental tray 10 of the present invention is inserted into a person's mouth so as to cover the entirety of the teeth of a particular arch, i.e., lower or upper arch. The dental tray 10 is held in place by the person for approximately 3 to 10 seconds or long enough for the dental tray 10 to warm to the normal temperature of a person's oral cavity at which point it is freely moldable to the specific contours thereof. By virtue of the material used and the configuration of the dental tray in and of itself, the dental tray 10 will become substantially flexible once it reaches the temperature of the person's oral cavity such that the person can more precisely fit the dental tray 10 over the dental arch by applying relatively gentle pressure thereto. That is, after the dental tray 10 warms to a temperature at or near that of the person's oral cavity, the material of the dental tray 10 is substantially pliable such that it is capable of conforming to a particular person's specific teeth profile, and further, the dental tray may be further manipulated by the person or a practitioner such as a dentist or hygienist to more closely match the person's teeth profile. In this manner, the dental tray 10 is deformed from its initial shape so as to more precisely correspond in shape to that of the person's particular mouth shape. For instance, the person may use his or her tongue, lips or fingers for molding the dental tray 10 to more closely fit around his or her teeth. Likewise, the person could use his or her teeth to bite down and enhance the fit therearound. Alternatively, as desired, the dentist or hygienist may use his or her fingers to ensure a snug fit. Once the dental tray 10 has been sufficiently conformed to the person's teeth, the dental tray 10 is then removed from the person's mouth and allowed to cool slightly such that the dental tray 10 becomes firm. Thus, the dental tray 10 maintains its shape and allows the person to apply treatment gels into the tray and reinsert the tray over the person's teeth as many times as desired after cleaning thereof.

Referring now to FIGS. 7 and 8, the dental tray 10 is shown after being fitted to a person's teeth and with a treatment gel 22 applied to the trough 20 thereof. As discussed previously, the treatment gel 22 may comprise a whitening, bleaching, mineralizing, desensitizing gel or any other such treatment gel adapted for application to a person's teeth. Thus, the treatment gels 22 are applied to the trough such that when the fitted dental tray 10 is inserted back into the person's mouth, the treatment gel 22 is applied to the person's teeth by virtue of the fitted nature of the dental tray 10. Moreover, the fitted nature of the dental tray 10 is such that the dental tray 10 may be worn while the person carries out normal day to day activities without adverse impact thereon. That is, the dental tray 10 has a relatively slim profile such that the wearer can insert the dental tray 10 at any point and treat his or her teeth without having to interrupt his or her activities.

In another embodiment of the present invention, the fitting of the dental tray 10 can occur simultaneously with the treatment of the treatment gel. In this embodiment, the treatment gel 10 is applied to the preformed dental tray 10 prior to insertion into a person's oral cavity. After the treatment gel 10 is applied, the dental tray 10 is inserted into the person's oral cavity and allowed to be fitted to the person's teeth profile. In this embodiment, the person simply wears the dental tray 10 until the treatment is complete. In this manner, the dental tray 10 is allowed to simultaneously apply the gel and fit the person's particular teeth profile, and due to the particular nature of the wax material from which the dental tray 10 is constructed, the dental tray 10 maintains its integrity throughout the treatment session.

It is specifically intended that the present invention not be limited to the embodiments and illustrations contained herein, but include modified forms of those embodiments including portions of the embodiments and combinations of elements of different embodiments as come within the scope of the following claim.

We claim:

1. A method for applying a dental treatment gel to a person's teeth, the method comprising the steps of:
providing a dental tray shaped to generally conform to a dental arch, the dental tray having a pair of opposing sidewalls interconnected between a bottom wall and terminating in a pair of spans thereby defining a trough for receiving the person's teeth;
inserting the dental tray into the person's oral cavity so as to receive the person's teeth within the trough;
allowing the dental tray to reach a temperature approximately that of the temperature of the person's oral cavity, such that the dental tray becomes fitted to the dental arch;
removing the dental tray from the person's oral cavity;
applying the treatment gel to the dental tray; and
treating the person's teeth with the treatment gel.

2. The method of claim 1, further comprising the step of cooling the dental tray.

3. The method of claim 1, wherein the step of applying the treatment gel to the dental tray occurs prior to the step of inserting the dental tray.

4. The method of claim 3, further comprising the step of cleaning the dental tray for subsequent reuse thereof.

5. The method of claim 1, wherein the dental tray is constructed from a wax.

6. The method of claim 5, wherein the wax is a food grade wax.

7. The method of claim 5, wherein the wax is configured to be relatively pliable at or above a temperature of the person's oral cavity.

8. The method of claim 5, wherein the dental tray is further constructed from a polymeric compound.

9. The method of claim 8, wherein the dental tray is constructed from at least 50% wax.

10. The method claim 1, wherein the treatment gel is one of a teeth whitening gel and a mineralizing gel.

11. The method of claim 1, wherein the dental tray is fitted to the dental arch in less than 10 seconds.

12. The method of claim 11, wherein the dental tray is fitted to the dental arch in between 3 and 10 seconds.

13. A dental tray corresponding to a dental arch comprising:
a lingual wall defining an inner wall of the body;
a labial wall defining an outer wall of the body;
a pair of spans defining a pair of ends and interconnected between the lingual and labial walls; and
a bottom wall interconnected with the lingual wall, the labial wall and the spans to thereby define an upwardly facing trough configured for receiving a person's teeth;
wherein the dental tray is constructed of at least a wax material, and wherein the wax material is configured to conform to a teeth profile of the person once the wax material reaches a temperature at or above a temperature of the person's oral cavity.

14. The dental tray of claim 13, wherein the dental tray comprises at least 50% wax material.

15. The dental tray of claim 14, wherein the dental tray is constructed of a polymeric compound.

16. The dental tray of claim 13, wherein the wax material is a food grade wax.

17. The dental tray of claim 13, wherein the dental tray comprises a thickness of 0.01 inch to 0.06 inch.

18. The dental tray of claim 17, wherein the dental tray comprises a thickness of 0.02 inch to 0.04 inch.

19. The dental tray of claim 13, further comprising a treatment gel applied to the trough of the dental tray for treatment of the person's teeth while the dental tray conforms to the person's teeth profile.

20. The dental tray of claim 19, wherein the treatment gel comprises one of a bleaching gel and a mineralizing gel.

21. The dental tray of claim 13, wherein the spans define an area of increased width at the ends of the dental arch as compared to the rest of the dental arch to thereby surround the person's molars.

22. A method of applying a treatment gel to teeth, the method comprising the steps of:
providing a dental tray constructed of a temperature-dependent pliable material and sized and shaped to accommodate a dental arch, the dental tray comprising,
a lingual wall defining an inner wall of the body;
a labial wall defining an outer wall of the body;
a pair of spans defining a pair of ends and interconnected between the lingual and labial walls; and
a bottom wall interconnected with the lingual wall, the labial wall and the spans to thereby define an upwardly facing trough configured for receiving a person's teeth;
inserting the dental tray into an oral cavity until it reaches a temperature at which the dental tray becomes pliable;
fitting the dental tray to a teeth profile;
removing the dental tray from the oral cavity to allow the dental tray to reach a temperature below that at which the dental tray becomes pliable;
applying a treatment gel to the trough of the dental tray;
reinserting the dental tray into the oral cavity;
positioning the dental tray such that the treatment gel contacts teeth of the oral cavity such that the treatment gel is applied to the teeth.
